(19) United States
(12) Patent Application Publication
(10) Pub. No.: US 2025/0252117 A1
(43) Pub. Date: Aug. 7, 2025

(54) DATA COMPLETENESS IN A DISTRIBUTED STORAGE SYSTEM

(71) Applicant: Schvey, Inc. d/b/a/Axoni, New York, NY (US)

(72) Inventors: Jeffrey Schvey, New York, NY (US); Nadi Sarrar, New York, NY (US)

(21) Appl. No.: 18/986,311

(22) Filed: Dec. 18, 2024

Related U.S. Application Data
(60) Provisional application No. 63/611,552, filed on Dec. 18, 2023.

(51) Int. Cl. G06F 16/27; G06F 16/22; G06F 16/23; G06F 21/60

(52) U.S. Cl. CPC G06F 16/275; G06F 16/2255; G06F 16/2379; G06F 21/602

(57) ABSTRACT

Provided are processes, systems, and methods for replicating data and verification of replicated data. A centralized storage node may generate shared values by which participant nodes may verify completeness of replicated data. For example, a hash sum based on data changes within the centralized data store may be determined and shared with a participant node for verification of completeness of replicated data. Data changes performed within the centralized data store are also communicated to the participant node for implementation on replicated data, and a local hash sum is determined by the participant node based on the data changes. If the local hash sum and the shared hash sum agree, completeness of one or more data entries within the replica database may be confirmed.

### CROSS-REFERENCE TO RELATED APPLICATIONS

This patent application claims priority to provisional application 63/611,552 filed Dec. 18, 2023, titled DATA COMPLETENESS. The entire contents of the aforementioned patent filings are hereby incorporated by reference for all purposes.

### BACKGROUND

### 1. Field

The present disclosure relates generally to computational systems, and more specifically, to replicating and verifying replicated data in a distributed system within a multi-tenant environment where tenant systems are also distributed.

### 2. Description of the Related Art

With the advent of computers, computer systems or applications relying on databases have proliferated. In many cases, multiple such computer systems or applications may benefit from access to data stored within a database. It is often impractical for geographically distributed systems, or systems that operate on many data items, to efficiently and reliably obtain data from a centralized database. Distributed databases or local database instances are often used to more closely locate data to the systems that rely on that data. In many cases, those systems too may be distributed and, as a result, the data utilized by those systems must be updated such that systems are operating on current data.

### SUMMARY

The following is a non-exhaustive listing of some aspects of the present techniques. These and other aspects are described in the following disclosure.

Some aspects include a process including updating, by a computing system and based on a database update, database data stored in a database within a multi-tenant environment, wherein the database data stored in the database includes tenant data that is associated with one or more tenants and respective tenant data for a respective tenant is maintained by one or more participant nodes as one or more respective database replicas of the respective tenant data; generating, the computing system, one or more database update messages, wherein each database update message is generated with respect to each tenant for which there are database events corresponding to that tenant since a last transmitted database update message for that tenant; and transmitting, the computing system, the one or more database update messages to one or more participant nodes that maintain a data replica for the respective tenant identified in the one or more database update messages.

Some aspects include a process including receiving, by a computing system that maintains a first database replica for a first tenant, a first database update message, wherein the first database replica for the first tenant is a replica of first tenant data of the first tenant stored in a database within a multi-tenant environment that is maintained by a centralized node, wherein the first database update message includes database events corresponding to the first tenant data for the first tenant since a last transmitted database update message for the first tenant, and wherein the database events include block information; updating, by the computing system, first database replica tenant data in the first database replica based on the database events in the first database update message corresponding to the first tenant associated with the first database replica; in response to determining there is a block update in the block information provided in the database events, verifying, by the computing system, whether a database replica data state matches that of a database data state of the database maintained by the centralized node and included in the block information; and in response to determining that the database replica data state does not match the database data state, transmitting a message to the centralized node to resend a block of database events transmitted in the first database update message for the first tenant since a last block update.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

Various other aspects, features, and advantages of the invention will be apparent through the detailed description of the invention and the drawings attached hereto. It is also to be understood that both the foregoing general description and the following detailed description are exemplary and not restrictive of the scope of the invention.

### BRIEF DISCUSSION OF THE DRAWINGS

The above-mentioned aspects and other aspects of the present techniques will be better understood when the present application is read in view of the following figures in which like numbers indicate similar or identical elements:

FIG. 1 illustrates a functional block diagram of an embodiment of data management system within which the present techniques may be implemented;

FIG. 2A is a functional block diagram of example interactions between components for which a database update message is generated by a centralized computing node, in accordance with some embodiments of the present techniques;

FIG. 2B is a functional block diagram of example interactions between components for which a database update message is processed by a participant node, in accordance with some embodiments of the present techniques.

FIG. 3 is a flowchart of a process for replicating and verifying replicated data, in accordance with some embodiments of the present techniques; and

FIG. 4 is a functional block diagram depicting an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the field of data replication, data storage and retrieval, and other fields. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments confirm that a participant (e.g., a computing node in a distributed application) is receiving all the data that it has been entitled to from a centralized data store in a hub and spoke environment (or other topology). The centralized data store may hold the data across a number of participants in a single or multiple databases by tagging every row in the table (or other entry, such as documents in a non-relational database) to indicate which participants own the corresponding data.

Some embodiments may implement a data completeness process that includes two components, referred to as Accumulator and Verifier, which may work together to ensure (or increase the likelihood) that data replicated to the member nodes of the distributed application is complete and correct. The Accumulator, which may reside on the centralized side, may compute a hash for all participants by looking at (e.g., computing the hash based on) every data change from the centralized data source (or at least some data changes). This computed hash may be relayed to all the participant nodes. The Verifier services, which reside on (e.g., are executed by) the participant node side, may recompute the hash based on the replicated data obtained at participant side and compare against the hash generated at centralized side. If the hashes match, the Verifier service may determine that the replication was successful, and if not, the Verifier service may indicate otherwise, e.g., within an error log, indicated status of a participant node, asynchronous error message or other form of notification.

The verification process may detect failures such as: a) Data in the member nodes replicas is modified manually or by another process; b) The data replication protocol does not sync all the data; c) Configuration errors where data is synced to the wrong database (e.g., test data being replicated to production); and the like.

Implementing distributed databases within multi-tenant environments, and especially where one or more tenant systems are also distributed, is challenging. A tenant is entitled to their data and tenant systems should have access to all the data to which they are entitled. Moreover, the data to which a tenant system is entitled to access, which may be stored by a storage node of a distributed database system, should be consistent with the same data stored by other storage nodes of the distributed database system. As data is updated, such as by addition of new data records, updating of existing data records, or deletion of data records, those updates need to be streamed to storage nodes of a distributed database to ensure consistency of their data for tenant system access.

Example embodiments of distributed database systems described herein may implement a data completeness process by which an entity (e.g., a tenant) is ensured that it is receiving or has access to all the data to which it is entitled (e.g., from a storage node of the distributed database system). Embodiments of a data completeness process may determine whether a participant (e.g., a node) received (or is receiving) all the data that it is entitled to from a centralized data store, such as in a hub and spoke environment. In some embodiments, a centralized data store may hold data corresponding to a number of participants in a single database or multiple databases by associating records with indications of (e.g., like tags indicating) a participant(s)'s ownership of certain records. A centralized storage node, such as a storage node implementing a centralized data store, may include an accumulator for generating shared value(s) by which participant nodes may verify completeness of replicated data (e.g., within a database replica). For example, the accumulator may compute hashes by examining data changes within the centralized data store and participant nodes may obtain hashes for verification of completeness of their replicated data. Participant nodes may include a verifier for generating local value(s) for comparison with shared value(s) obtained from the centralized node. For example, the verifier of a participant node may compute a local hash by examining data changes within a replica database maintained by the participant node and compare the local hash with a shared hash obtained from the centralized storage node. If the local hash and the shared hash agree, completeness of one or more data entries within the replica database (e.g., whether replica database state matches centralized database state) may be confirmed (or guaranteed).

Embodiments of the data completeness process are expected to improve detection of failures (or otherwise maintain data integrity) such as when data maintained by a participant node is modified manually or by another process, a data replication protocol does not sync data to one or more participant node(s), and configuration errors where data is synced to an incorrect database (e.g. test data being synced to production data). Moreover, embodiments are expected to decrease downtime to rebuild databases by fast identification of point in sequence or time sync failures to minimize time to resync replica database state with centralized database state.

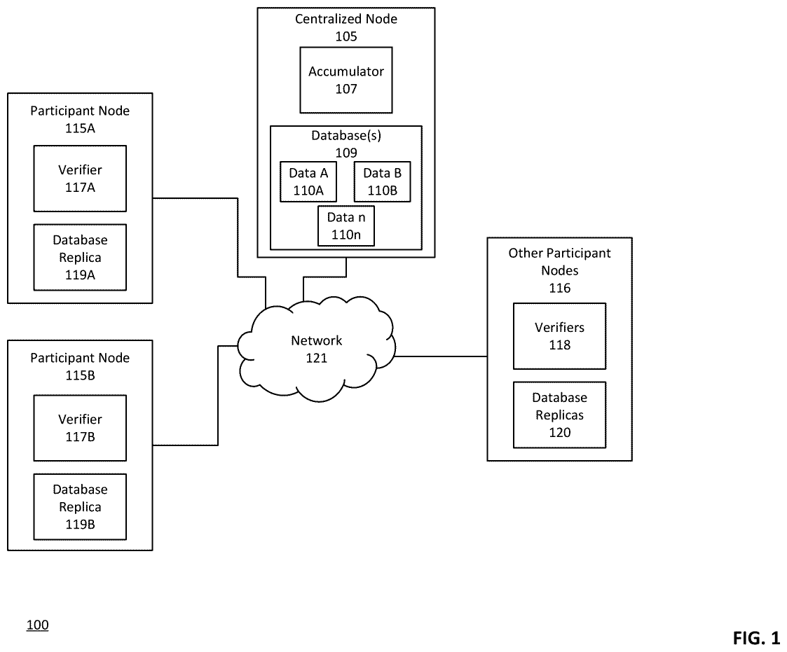

FIG. 1 illustrates a functional block diagram of an embodiment of data management system 100 within which the present techniques may be implemented. The data management system 100 is established to persist data across various distributed databases, such as geographically, among different entities, or both, via network 121. A centralized storage node, like a centralized node 105, may manage one or more databases 109 storing data. Different data within the database(s) 109 may correspond to different tenants within a multi-tenant storage environment. For example, a given tenant may operate (or use) one or more participant nodes, like a participant storage node, which maintains a replica database storing at least some data maintained by the centralized node. Other tenants may similarly operate (or use) one or more other participant nodes. In some examples, a replica database maintained by a participant node may store only data corresponding to the tenant operating the node. In some examples, multiple tenants may share a participant node, in which case a replica database maintained by that participant node may store data corresponding to each of those tenants. In either case, tenants may be restricted from accessing data of other tenants (which should not be construed as preventing access to a portion of a tenant's data to which another tenant is permissioned to access by the tenant). Each of the participant node 115A, participant node 115B, and other participant nodes 116, and the centralized node 105 may communicate via the network 121, which is not to suggest that each entity must communicate with each other entity, or that entities cannot communicate with other entities, like client devices, server devices, or applications, that may be used to access tenant data or provided with information based on tenant data.

In some examples, applications or services like a verifier or accumulator of a node may be executed on a computing device (e.g., like a compute server or server system) different than a computing device (e.g., storage server or server system) storing a database, though this need not be a requirement. For example, some nodes may execute a verifier or accumulator and store data on a single computing system (which is not to suggest that such a computing system may not comprise multiple computing devices, or that each computing device need be similar or provide similar functionality). In some embodiments, different ones or collections of participant nodes may be operated by different entities (e.g., tenants), and participant nodes of a given collection of participant nodes (e.g., of a given tenant) may be distributed geographically. In some examples, two or more tenants may share a participant node. In some examples, the various participant nodes may be distributed geographically and store data corresponding to a plurality of tenants, or each tenant. Thus, depending on the embodiment, database replicas 119A, 119B, 120, may store all or some of the data 110A-n maintained within database(s) 109.

In some example embodiments, the centralized node 105 may be a computing device or computing system (e.g., a collection of computing devices) that manages data stored in database(s) 109. For example, the centralized node 105 may receive database updates from one or more applications, such as various applications operated by various tenants. Tenant application data may be stored within records within the database(s) 109. In some examples, a record may be an entry in a table. For example, a record may correspond to an entry within a table, like a row of data within a table, and record data may comprise data values within one or more columns within the table. In other examples a record may correspond to an entry of a column, and record data may comprise data values within one or more rows within the table. Record data need not be stored within a data structure that is a table to constitute a table. Other example data structures such as linked lists of vectors or records from which a table may be constructed may be used. Accordingly, description of a table should not be construed as being limited to a specific data structure as data from which a table may be constructed may be stored in a variety of different ways. In another example, a record may be an entry in a lookup table.

In some example embodiments, the centralized node 105 may convey information about database 109 state in response to database updates received from one or more applications, such as various applications operated by various tenants, to one or more participant nodes 115, 116. Information about database 109 state may include replica database state update information for updating one or more database replicas 119, 120. Thus, for example, when Data A 110A is updated, information about the update and the state of Data A may be conveyed to one or more participant nodes 115, 116 as replica database state update information. In a multi-tenant environment, database 109 may store different data corresponding to different tenants, such as Data A 110A corresponding to a tenant A, Data B 110B corresponding to a tenant B, and so on (e.g., up to Data n 110n for an nth-different tenant). In some examples, each different tenant may operate one or more participant nodes 115, 116. Thus, for example, participant nodes 115A, 115B may correspond to a tenant A and database replicas 119A, 119B may store a replica of Data A 110A and other participant nodes 116 or collections thereof corresponding to other tenants may store respective tenant data (e.g., Data B 110B through Data n 110n). In another example, such as where a participant node 115A corresponds to a tenant A and a participant node 115B corresponds to a tenant B, database replica 119A may store tenant A Data A 110A and database replica 119B may store tenant B Data B 110B (which is not to suggest that tenant A may not operate one or more of the other participant nodes 116 that also store Data A 110A in their database replicas 120, and likewise for tenant B for Data B 110B).

In some examples, the centralized node 105 conveys replica database state update information to one or more participant nodes using a message service, such as Kafka or RabbitMQ. Each message may include information about updates within database(s) 109 that occurred within a time slice after a prior message was generated for transmission. In other words, the centralized node 105 may stream time slices of updates to data within database(s) 109 to participant nodes 115, 116. Not all participant nodes 115, 116 may receive (or act on) each message, for example, only those participant nodes maintaining a database replica that should store data that was updated within database(s) 109 may be updated (e.g., for a given time slice). If database replicas 119A, 119B each store a replica of Data A 110A, and other participant nodes 116 do not, only participant nodes 115A and 115B need to update their database replicas when Data A is updated (or otherwise modified). Some embodiments of the centralized node 105 may transmit an update message to specific nodes, such as to participant node 115A and 115B (and not the other participant nodes 116) when Data A 110A is updated. In other examples, the centralized node 105 may transmit update messages to all participants nodes, and each participant node may parse each received update message to obtain (any) data pertaining to the database replica maintained by that participant node.

Embodiments of the centralized node 105 may include an accumulator 107 to determine one or more verification values after updating the database(s) 109. For example, after Data A 110A is updated, one or more verification values may be determined based on Data A 110A by the accumulator 107. A participant node, e.g., 115A, that maintains a database replica 119A for storing a replica of Data A 110A may receive the one or more verification values in association with a database state update, like a database update message. Message contents may include data updates to database replica 119A such that the replica of Data A may be updated by the participant node 115A to be current to the Data A 110A stored by the database(s) 109, and the one or more verification values may be used by the participant node for verification that the updated replica of Data A is current (e.g., matches) the version of Data A 110A maintained by the centralized node 105 at the time the database state update was generated.

State latency between database 109 data and a database replica (e.g., 119A) data may correspond, generally, to a sum of time between modification of data in the database for which database replica data is to be updated and transmitting of an update message is transmitted to the database replica 119A, and between the transmitting of the update message and receipt of the update message at the participant node 115A by which with database replica data is updated. In some examples, the centralized node 105 may stream database 109 update messages with low-latency (e.g., 100 ms, 30 ms, or less) between messages (e.g., for a given database replica) to one or more participant nodes 115, 116 (which is not to suggest that a given participant node need receive every sequential message within 100 ms, as database replica state may remain current, but rather that in some embodiments database replica state may be updated within approximately 100 ms (or less) when database 109 data state to be stored in that database replica changes at the centralized node 105).

In some example embodiments, a participant node 115, 116 may be a computing device or computing system (e.g., a collection of computing devices) that manages data stored in a database replica 119, 120. Embodiments of a participant node may receive database updates from the centralized node 105, such as for updating data within a database replica so that database requests may be serviced by the participant node with current data (e.g., database replica data state being updated to match database 109 data state). For example, one or more applications, such as various applications operated by various tenants, may request data and those database requests may be serviced by participant nodes (e.g., in addition to or instead of the centralized node 105 to offload or distribute request processing).

As described above, tenant application data may be stored within records within the database(s) 109 of the centralized node 105, and replica data (e.g., replica records) may be stored within a database replica of a participant node for servicing application data requests (instead of or in additional to servicing by the centralized node). Example database replicas may store replica data records in data structures similar to those employed by the database 109, though they need not be the same. For example, the centralized node 105 may store JSON (JavaScript Object Notation) data and the participant nodes may store JSONB data, a decomposed binary data format. The decomposed binary data form (JSONB) of the JSON data (which preserves additional, typically insignificant data, lost in conversion to JSONB) can be slightly slower at input as a result of the conversion overhead, but may increase output efficiently as no reparsing is required. Moreover, JSONB data may be indexed which can provide further advantages for retrieval operations. For example, a record may correspond to an entry within a table, like a row of data within a table, and record data may comprise data values within one or more columns within the table. In some example embodiments, in contrast to database 109, a database replica may store only a portion of data stored in the database 109, such as only a portion of data specific to a tenant (e.g., the tenant operating the participant node managing that replica database).

In some example embodiments, each participant node 115, 116 corresponds to a given tenant (and a tenant may utilize multiple participant nodes). The one or more participant nodes (e.g., 115A and 115B) that correspond to a given tenant may receive database updates from the centralized node 105 based on changes to that tenant's data (e.g., Data A 110A) within the database 109. In turn, those participant nodes 115A, 115B may update their database replicas 119A, 119B based on the received database updates. The verifiers 117A, 117B of each of the participant nodes 115A, 115B may determine one or more database replica verification values based on the respective database replicas 119A, 119B after respective entry of the database update. Thus, for example, in response to receipt of a database update by a participant node, its database replica may be updated based on the database update and one or more database replica verification values determined based on the database replica state after the update. A database replica verification value determined by a participant node may be compared to a verification value received from the centralized node 105 for verification that database replica data state matches that of the database 109.

Database updates may be received by a participant node over a message service, such as Kafka or RabbitMQ. Each database update message received by the participant node may include information about updates to data within database(s) 109 that occurred within a time slice since a prior message was received and are to be replicated in the database replica of the participant node. In other words, the participant node may receive a stream of time slice database updates from the centralized node 105 for updating of its database replica. In some example embodiments, a participant node may only receive database update messages pertaining to that participant node, e.g., each database update message received by that participant node applies (or should apply) to the database replica it maintains. In some example embodiments, not all database update messages received by a participant node may contain database updates to the database replica maintained by the participant node, and the participant node may parse a database update message to determine whether it should be applied to the database replica or discarded. In some examples, participant nodes may parse receive database update messages for other information, such as an identifier to determine whether the database update message was already processed, or to determine whether a receive database update message is a next database update message (e.g., in an ordered sequence of database update messages) to be processed.

Embodiments of the centralized node 105 may transmit, such as in association with database updates, information by which participant nodes may verify database replica state. For example, the centralized node 105 may determine with the accumulator 107 one or more values by which a participant node may verify database replica state (e.g., as matching that of some or all of the data stored in database 109). In some examples, one or more verification values are included within a message including database update information. For example, for a change in Data A 110A, the accumulator 107 may determine one or more verification values, and the one or more verification values may be included in a database update message indicative of the change in Data A. Accordingly, when a participant node, e.g., 115A, that maintains a database replica 119A of Data A 110A stored by database 109 receives the database update message, the database replica may be updated and the resulting state of the database replica verified based on the one or more verification values. The participant node 115A may, for example, update the database replica 119A based on database update information included in the message and the verifier 117A may determine one or more database replica verification values. The one or more database replica verification values determined by the verifier 117A of the participant node 115A may be compared to the one or more verification values determined by the accumulator and obtained by the participant node 115A in association with the update message, a match between the one or more values determined by the verifier 117A with the one or more values determined by the accumulator 107 being indicative of verification of matching database state (e.g., database replica 119A maintaining a current version of Data A 110A, as of the update message).

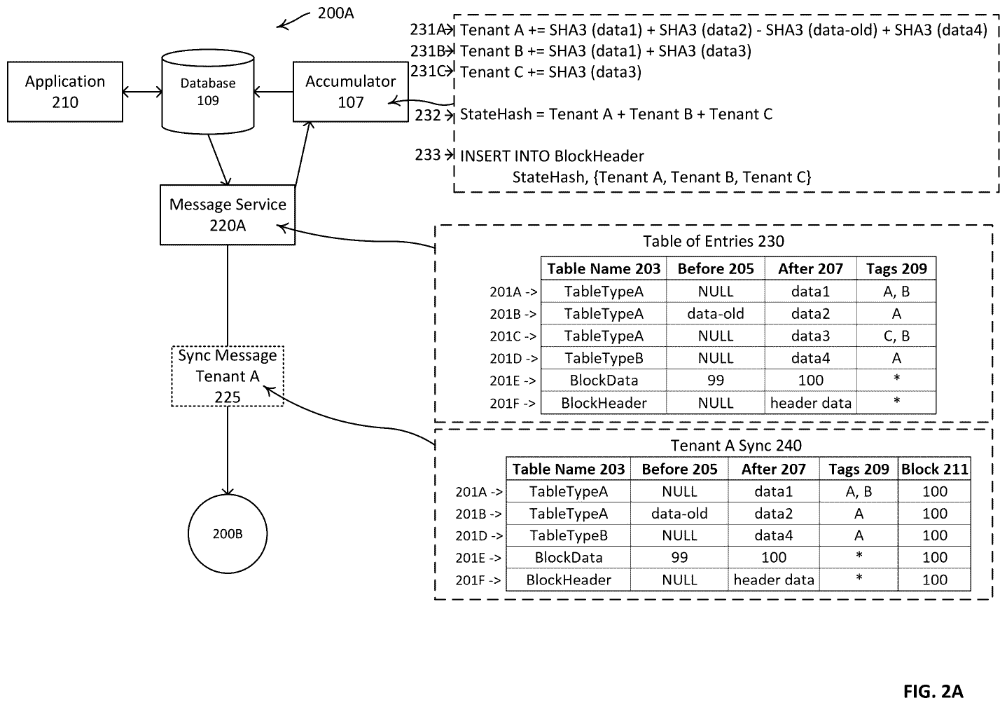

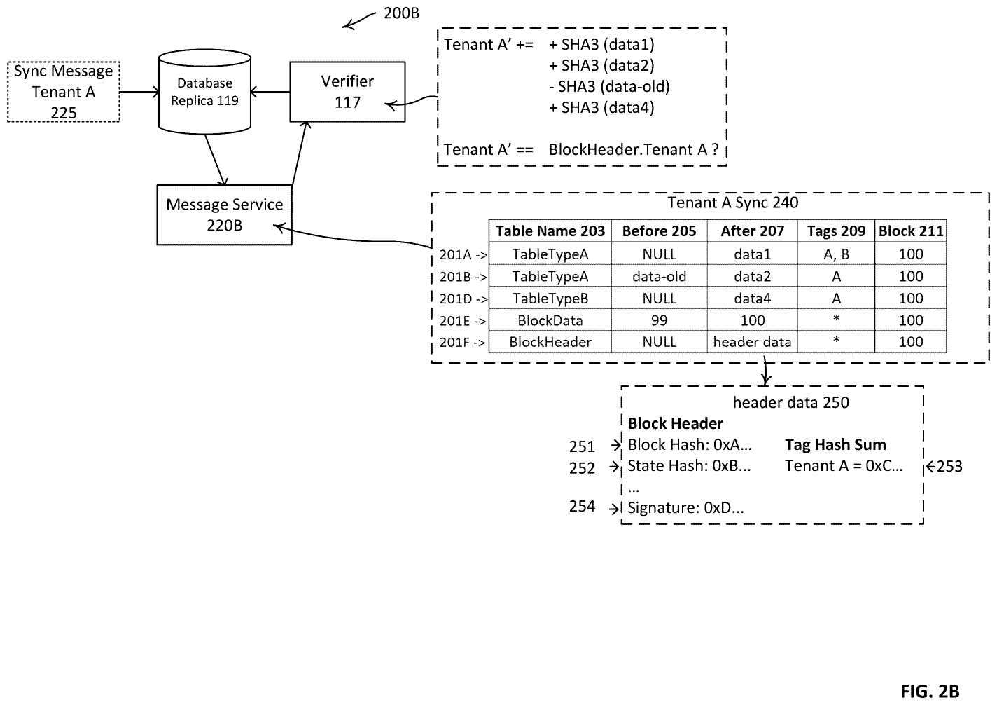

FIG. 2A is a functional block diagram of example interactions 200A between components for which a database update message is generated by a centralized computing node to sync a replica database of a participant node in accordance with some embodiments of the present techniques. In some examples, a centralized node may receive one or more updates from an application 210, such as application updates to data stored within the database 109 maintained by the centralized node.

An example of application 210 logic updates to data stored within the database 109 may include one or more updates to one or more tables. For example, a sequence of updates from an application 210 may include one or more operations such as:
INSERT INTO TableTypeA (id, value, tags, . . . ) VALUES (n1, data1, [A, B], . . . )
UPDATE TableTypeA SET value=data2 WHERE id=n1
INSERT INTO TableTypeA (id, value, tags, . . . ) VALUES (n2, data3, [C, B], . . . )
INSERT INTO TableTypeB (id, value, tags, . . . ) VALUES (n3, data4, [A], . . . )
etc. . . .
   Here, values are inserted into two different tables (or types of tables) and a value in one of the tables is updated. The above operations are shown as events 201A-201D within example table of entries 230 that may be performed within example database 109. The table of entries 230 shows some examples of information that may be included or associated with an operation, such as a table name 203, a before 205 value, an after 207 value, and any tags 209. Table name 203 may correspond to a target table or type of table in which an operation is to be performed, like TableTypeA (e.g., a Table A), TableTypeB (e.g., a Table B), a BlockData table, and a BlockHeader table.

Example operation of:
INSERT INTO TableTypeA (id, value, tags, . . . ) VALUES (n1, data1, [A, B], . . . )
   may correspond to event 201A in the table of entries 230, such as an entry of a data1 value (after 207) within TableTypeA (table name 203). The id may serve as an identifier (which may be a unique identifier) for an entry, such as data stored in a row of that table, and oftentimes the id may also be a primary key of that table. As the operation corresponds to entry of a new value (or record), the before 205 value may be indicated as NULL (or other value indicative of a NULL condition) because no prior value (or record) changed. Tags 209 associated with the operation may indicate to which tenants the event 201A corresponds, e.g., Tenant A and Tenant B (and not Tenant C or other tenants) by tags 209 “A, B.”

Example operation of:
UPDATE TableTypeA SET value=data2 WHERE id=n1
   may correspond to event 201B in the table of entries 230, such as an entry of a data2 value (after 207) within TableTypeA (table name 203) in place of a data-old (before 205) entry. For example, WHERE id=identifier of a prior entry, e.g., n1 in the above operation, may be used to indicate which row data (e.g., data1) in a table is to be updated with the new value (e.g., data2). As the operation corresponds to setting an updated value (or record) of an existing one, the before 205 value is not NULL, but rather the data-old value of a record that is updated by the operation. Tags 209 associated with the operation may indicate to which tenants the event 201B corresponds, e.g., Tenant A (and not Tenant B or Tenant C or other tenants) by tags 209 “A.” Applicants note that while the example operations describe the entry of data1 (e.g., corresponding to event 201A), and then the replacement of data1 (e.g., data-old from before 205) with data2 (e.g., corresponding to event 201B) by a subsequent operation, these operations need not occur sequentially. For example, data-old could correspond to data0 (not shown) or any other data that was previously entered (not shown) for a provided id (e.g., n0 for data0, or nX for some other dataX within TableTypeA) to replace that prior data with data2.

Example operation of:
INSERT INTO TableTypeA (id, value, tags, . . . ) VALUES (n2, data3, [C, B], . . . )
   may correspond to event 201C in the table of entries 230, such as an entry of a data3 value (after 207) within TableTypeA (table name 203). As the operation corresponds to entry of a new value (or record), the before 205 value may be indicated as NULL (or other value indicative of a NULL condition) because no prior value (or record) changed. Tags 209 associated with the operation may indicate to which tenants the event 201C corresponds, e.g., Tenant C and Tenant B (and not Tenant A or other tenants) by tags 209 “C, B.”

Example operation of:
INSERT INTO TableTypeB (id, value, tags, . . . ) VALUES (n3, data4, [A], . . . )
   may correspond to event 201D in the table of entries 230, such as an entry of a data4 value (after 207) within TableTypeB (table name 203). As the operation corresponds to entry of a new value (or record), the before 205 value may be indicated as NULL (or other value indicative of a NULL condition) because no prior value (or record) changed. Tags 209 associated with the operation may indicate to which tenants the event 201D corresponds, e.g., Tenant A (and not Tenant B or Tenant C or other tenants) by tags 209 “A.”

Accordingly, example table name 203 information may correspond to a table in which an entry or record is to be added or updated by an operation, before 205 value information may correspond to a prior value, after 207 value information may correspond to a new or updated value, and tags 209 may indicate for which tenant (or tenants) the operation is performed. For example, tags 209 may be used to permission which ones of a plurality of participant nodes should receive information about an operation to be performed in their database replicas. A tag 209 value that corresponds to a tenant may be any value that identifies the given tenant from other tenants. Participant nodes associated with a tenant and storing replicated data from the database 109 for that tenant may be selected for receipt of a database update message indicating one or more operations to be performed based on tags 209 (e.g., that indicate that tenant).

In some example embodiments, the accumulator 107 is configured to communicate with the database 109 and message service 220A. The accumulator 107 may increment a current block number in a table, e.g., BlockData, which may be maintained by a centralized node, e.g., with the database 109 and used for database verification checkpoint intervals. BlockData table data may include a block number value used to coordinate among participant nodes exactly where in a stream of database updates verification “checkpoints” occur based on their block numbers. A current block number may be incremented (e.g., after a given period of time, number of operations, or other setting) to a new block number to indicate a new verification checkpoint. As shown, table of entries 230 may include event 201E about an increment to a block number within a BlockData table, e.g., an increment of block number 99 (before 205) to a new current block number 100 (after 207). The event 201E about an increment to a block number may be communicated to any participant node within a respective database update message, and thus need not be tagged as corresponding to any specific tenant. In some examples, the BlockData table is synced to participant nodes like any other table, and a special tag 209 (e.g., “*”) may be used to indicate that every participant node is permissioned to receive information about the operation to update the BlockData table.

In some example embodiments, the message service 220A is configured to obtain information about database 109 events, such as information about operations performed within the database like those in table of entries 230 from a database event log. The database events may convey information similar to that indicated in the table of entries 230 for a corresponding operation. For example, a database event based on the example UPDATE operation described above having associated event 201B might be:

```
{
  “TableName”: “TableTypeA”,
  “before”: {“id”: n1, “tags”: “A, B”, “value”: data1, ...},
  “after”: {“id”: n1, “tags”: “A, B”, “value”: data2, ...},
}
```

where n1 is the identifier for the entry containing data1, and data1 is the before 205 data-old value replaced with the after 207 data2 value in accordance with the example UPDATE operation. The information about database events caused by applications (e.g., application 210 and events 201A-201D) and information about other events (e.g., events 201E-201F) for database replica update and verification processes (e.g., BlockData table current block updates and BlockHeader header data information for blocks) obtained by the message service 220A may be used to generate database replica updates conveyed to participant nodes for updating tenant data, such as via database update messages. A database update message for updating a replica database, like a sync message, may include information about database events specific to the tenant using that replica database. As a tenant may use multiple participant nodes which each should store a current version of tenant data, a sync message may be transmitted to each of the one or more participant nodes used by that tenant to update their respective database replicas to a same replica database state matching that of tenant data (e.g., all prior and new events considered for the database update message) within database 109.

Concurrently, the accumulator 107 may obtain information about database 109 events (e.g., 201A-201D), such as from the database event log or the message service 220A. The accumulator 107 may calculate hashes (e.g., based on database event information) that will be published as part of header data within a BlockHeader table (e.g., database event 201F), and the header data may correspond to a given block 211 (e.g., block 100) within the BlockData table to which those database events (e.g., 201A-201D) correspond. Hashes generated by the accumulator 107 may correspond to database state information that uniquely summarizes the current state of the database 109 after each database update. Some embodiments may save database state information to summarize database 109 state after encountering an update to a current block (e.g., a change in the current block to block 100 from block 99) in the BlockData table.

In some embodiments, database 109 events are accumulated into a single hash that represents the state of the database at the time of a BlockData table update to a next block. Prior to determining the single hash, a component state of tenant data in the database with respect to each tag (e.g., tenant) may be determined by hashing corresponding database events. For example, for each database event, the accumulator 107 may: 1) hash before 205 value, or set to 0 if null; 2) hash after 207 value, or set to 0 if null; and 3) accumulate a running sum of hash values with respect to each tag 209. Values (e.g., before and after values) may be deterministically serialized, such as by a Recursive-Length Prefix (RLP) serialization protocol to encode a representation of structured data prior to hashing (e.g., such that a matching of hashes is indicative of same content and structure). A running sum, in some examples, may comprise the subtracting of hash values based on before 205 values and addition of hash values based on after 207 values, or vice versa. In an example for Tenant A, represented by tag A, a running sum 231A may be determined based on SHA3 hashes of before 205 values and after 207 values in the events for which tenant A is tagged, e.g., 201A, 201B, and 201D, yielding a Tenant A hash=SHA3(data1)+SHA3(data2)-SHA3(data-old, e.g., data1 in accordance with the above described example operations)+SHA3(data4) for negatively signed before and positively signed after values. Similarly, for Tenant B and Tenant B, running sums 231B and 231C may be determined based on the respectively tagged events (e.g., 201A and 201C for Tenant B and 201C for Tenant C). In accordance with some above-described examples where data-old=data1 for an UPDATE of id=n1 with data2, Tags 209 for event 201B may further include a Tenant B tag in addition to the Tenant A tag (e.g., because both tenants were permissioned to the entry by event 201A). In such an example where Tenant B is also tagged 209 for event 201B, a corresponding example running sum 231B for Tenant B would further include, as in the example for Tenant A, a positively signed SHA3(data2) and negatively signed SHA3(data1), e.g., Tenant B+=SHA3(data1)+SHA3(data2)−SHA3(data1)+SHA3(data3).

In turn, the Tenant A, Tenant B, and Tenant C running hash sums (e.g., component hash values) may be summed to determine the single StateHash 232. As can be seen, rows in table of entries 230 with multiple tags may be intentionally double counted with respect to the StateHash, but only counted once with respect to each tagged Tenant. The StateHash and component hash sums may be stored, such as by insertion 233 as BlockHeader data, and may be performed upon completion of a block (which is not to suggest that BlockHeader data may not include other data, such as a hash of the completed block (or all completed blocks or completed block and prior block) or cryptographic signature of such data by the accumulator 107 with a private key to ensure non-repudiation).

Database events may be synced (e.g., via database update messages) to participant nodes based on permissions corresponding to tags. For example, a first subset of participant nodes may be permissioned to receive database events corresponding to tag A, a second subset of participant nodes to those corresponding to tag B, and a third subset of participant nodes to those corresponding to tab C, and so on. In some examples, the message service 220A (or a sync server for communicating messages) may store information about permissions describing which participant nodes are permissioned to which tags. In some examples, participant nodes may be identified by the SAN (Subject Alternative Name) value of their TLS (Transport Layer Security) certificates, or other identifier. In some embodiments, a lookup table may match participant node SAN values and tags, or vice versa.

In some embodiments, a database update message may include information about a block update. For example, upon completion of a block, information about a block update stored in the database 109 may yield one or more database events based on updating of one or more tables like BlockHeader and BlockData. BlockHeader and BlockData database events may be handled similar to other database events in that they are communicated to participant nodes in database update messages, except that they may be included in each database update message as they are permissioned for receipt by all participant nodes (e.g., as indicated by “*” within tags 209 instead of one or more tags corresponding to tenants).

The message service 220A (or a sync server for communicating messages) may generate database update (e.g., sync) messages for updating participant nodes of tenants. As shown, the message service 220A may generate a sync message 225 for updating a subset of participant nodes permissioned to receive Tenant A data (e.g., database events tagged 109 within a Tenant A identifier, e.g., “A” in the example table of entries 230). An example tenant A sync 240 table indicates an example subset of information from the table of entries 230 that may be transmitted to participant nodes permissioned to receive tenant A data. As shown, the example tenant A sync message may include information about application 210 database events 201A, 201B, and 201D, as each of those events within the table of entries 230 include the “A” tag 209 corresponding to tenant A. Additionally, the example tenant A sync message may include information about block update date events 201E and 201F, as those database updates are permissioned to all participant nodes with the “*” tag 209. Example sync messages may indicate to which block 211 each database event corresponds as shown in the tenant A sync 240 table, e.g., block 100 in the present example. The sync message 225 for Tenant A may be transmitted to the subset of participant nodes permissioned to receive Tenant A data, each of which may be identified based on the SAN value of their TLS certificate, which may be associated with the “A” tag 209.

Sync messages may also be generated to update other subsets of participant nodes. For example, one or more additional sync messages may be generated to include selections of database events for respective other subsets of participant nodes based on the tags 209 within the table of entries 230. In accordance with the example table of entries 230, a sync message corresponding to a subset of participant nodes permissioned to Tenant B data may include information about application 210 database events 201A and 201C, and another example sync message corresponding to a subset of participant nodes permissioned to Tenant C data may include information about application database event 201C. These sync messages, like the example sync message 225 for Tenant A, may each also include information about the block update database events 201E and 201F. The sync messages for Tenant B and Tenant C may be transmitted to the respective subsets of participant nodes permissioned to receive respective data, each of which may be identified based on the SAN value of their TLS certificate, such as by respective association with the “B” or “C” tags 209.

FIG. 2B is a functional block diagram of example interactions 200B between components for which a database update message including information about database updates at a centralized node is processed by a participant node to update and verify a replica database of the participant node in accordance with some embodiments of the present techniques. In some examples, a participant node may receive a database update message, like a sync message for syncing a state of database replica data to a state of data of a database of the centralized node. Thus, for example, database requests received at the participant node, which may be geographically distributed from the centralized node, may be serviced with database replica data by the participant node instead of with database data by the centralized node.

As shown, a participant node may receive a sync message 225 for Tenant A, such as for updating Tenant A data to which the participant node is permissioned within the database replica 119. The sync message may be received via a message service 220B, such as Kafka, RabbitMQ or other message service. In some examples, a message corresponding to the message service 220B may be transmitted by another protocol that wraps message data and the participant node may unwrap and then pass the message to the message service 220B. In either case, a received database update message may include a sequence of database updates that were performed within the database of the centralized node. For example, the database update message may include information, like that shown in the example Tenant A Sync 240 table, about one or more database events that occurred within the database of the centralized node based on application activity (e.g., database events 201A, 201B, and 201D) and internal processes such as block updates (e.g., database events 201E and 201F).

The participant node may update the database replica 119 based on the database update message (e.g., sync message 225 for tenant A), such as by performing database operations corresponding to the database events 201A-201F indicated within the message. For example:

```
INSERT INTO TableTypeA (id, value, tags, ...) VALUES (n1, data1, [A, B], ...)
  UPDATE TableTypeA SET value=data2 WHERE id = n1
  INSERT INTO TableTypeB (id, value, tags, ...) VALUES (n3, data4, [A], ...)
  INSERT INTO BlockData (id, tags, ...) VALUES (100, [*], ...)
  INSERT INTO BlockHeader (id, state_hash, tags, ...) VALUES (100, <header
data>, [*], ...)
```

An example of header data 250 is shown, and may include information such as a Block Hash 251, State Hash 252, Tenant A hash 253, and a Signature 254 (e.g., a cryptographic signature of header data by the centralized node that ensures non-repudiation).

In some embodiments, prior to updating the database replica 119, the participant node may verify signature 254, such as by a signature verification algorithm that takes as input a public key (e.g., a signature verification key) corresponding to the centralized node and a set of data that was signed. In some examples, the participant node may determine its own result for all or some data in the set of data that was signed and use that result as data input. Failure to verify signature 254 may cause the participant node to reject a sync message.

After updating the database replica 119, the verifier 117 of the participant node may determine a Tenant A′ (prime) hash based on database replica data. For example, the verifier 117 may obtain database replica events, such as via the message service 220B, which describe before and after values for operations performed within the database replica 119. The before 205 and after 207 values corresponding to database events at the centralized node should, for a successful sync to update database replica state to that of the database of the centralized node, match before and after value for database events at the participant node. The participant node may determine Tenant A′ hash representation of these events as effected within the database replica 119 for Tenant A data (e.g., similar to how the centralized node determines Tenant A hash 253 as a component hash of state hash 252). The verifier 117, for example, may determine Tenant A′ hash by determining a running sum, which in some examples may comprise the subtracting of hash values based on before values and addition of hash values based on after values (e.g., in accordance with an example described for the centralized node). Thus, a Tenant A′ hash based on 201A, 201B, and 201D events (assuming they are correctly reproduced in the database replica with same before and after values), may yield a Tenant A′ hash=SHA3(data1)+SHA3(data2)-SHA3(data-old, e.g., data1 in accordance with the above described example operations)+SHA3(data4). The verifier 117, upon detecting a block update, e.g., based on BlockData and BlockHeader database replica events, may take the Tenant A′ hash resulting after committing database updates prior to the block update and determine whether it matches the Tenant A hash determined by the centralized node that is included in the header data, e.g., “Tenant A′==BlockHeader. Tenant A?” A match between the Tenant A′ hash determined by the verifier 117 and the Tenant A hash determined by the centralized node (e.g., by the accumulator) is indicative of matching data state for Tenant A between the participant node and the centralized node. Thus, for example, when the Tenant A′ hash and Tenant A hash match, the participant node database replica may be deemed successfully synced to the centralized node database with respect to Tenant A data. Some embodiments of a participant node may be permissioned to the data of multiple tenants, in which case a hash with respect to each tenant may be determined (e.g., based on Tags 209) in a similar fashion to determining component hashes by the centralized node, and each Tenant n′ hash may be compared to a respective Tenant n hash within header data 250.

In a case where a Tenant n′ hash determined by the participant node does not match a Tenant n hash within the header data 250, the participant node may be determined to be out of sync with the centralized node, e.g., the tenant data state at the participant node differs from the centralized node. A difference in tenant data state, traditionally, may arise from a manual modification or a process that modifies data within the replica database that was not similarly modified within the database of the centralized node, if not all data is synced, or configuration errors in which data is synced to a wrong database. Such issues are substantially mitigated in general operation of the present techniques, such as by restricting modification of database replica data to only those operations corresponding to database updates, checkpoints for tracking updated replica database state, and use of tags (e.g., to ensure database updates are conveyed correctly to database replicas). Additionally, some examples may track a count of operations or messages for a block or implement identifiers indicating sequencing of operations or messages for a block (e.g., to identify a database update message or one or more events not received prior to receipt of a block update or subsequent message or event).

However, should a difference between Tenant n′ hash and Tenant n hash be detected, embodiments may rebuild database replica data state efficiently. For example, the verifier 117 may recursively check state corresponding to one or more checkpoints (e.g., blocks) to determine last where replica database state matched centralized node database state. In some examples, the verifier 117 may unwind database replica state, such as by playing database events backwards from a log of database replica events until reaching a prior block update to arrive at a prior state of the database replica. After verifying that the prior state of the database replica matched the corresponding state of the database of the centralized node, the participant node may request a re-sync from the centralized node for the block that was unwound to receive one or more database update messages corresponding to the block from the centralized database. Re-sync of tenant data stored by a participant node from the database of the centralized node may be performed on a block-by-block basis, with each block corresponding to a checkpoint.

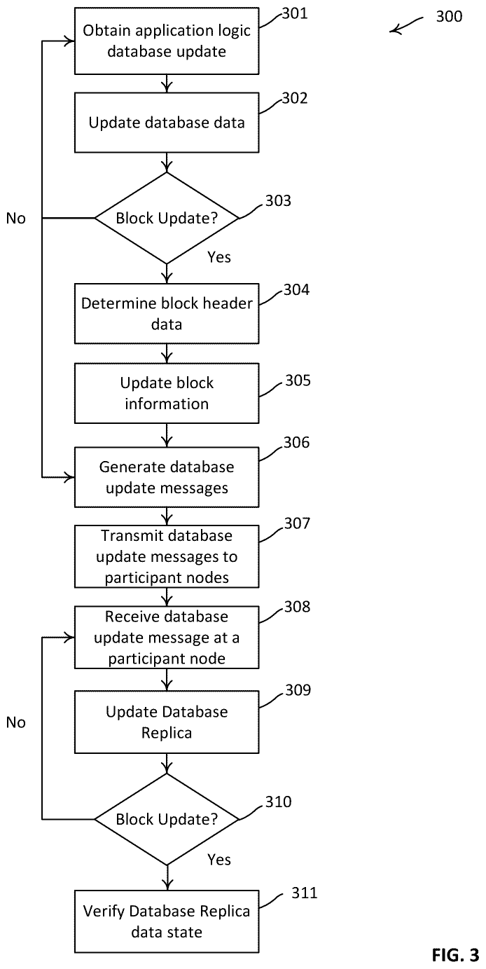

FIG. 3 is a flowchart of a process 300 for replicating and verifying replicated data, in accordance with some embodiments of the present techniques. In some embodiments, the process may be implemented by computing systems within a distributed storage system. Embodiments of the distributed storage system may include various computing systems within a multi-tenant environment where one or more tenant computing systems are also distributed.

In step 301, a computing system may obtain an application logic database update. The computing system may be a centralized node of a distributed storage system that maintains a database comprising tenant data within a multi-tenant environment. The centralized node may obtain, such as from one or more applications, logic database updates to add, modify, or delete data within the database. The database of the centralized node may store a plurality of tables and application logic database updates may indicate to which table an operation corresponds. For example, a record and associated values, like a row of data, may be added to a table within the database based on logic operations obtained from an application. The record may contain one or more values, such as within one or more columns of the table, and existing values may be modified or deleted or new values may be added based on logic operations obtained from an application. The table may store data corresponding to one or more tenants, such as a set (or subset) of tenants utilizing the distributed storage system. Some example embodiments may segment a table into multiple tables, such as a plurality of sub-tables, each corresponding to a respective tenant in a set of tenants for which data is stored in the table. Each of the sub-tables may be associated with a tag corresponding to a given tenant to indicate permissions of that tenant to access the data within the sub-table. Segmentation of the table should not be construed as a requirement for separate data structures (which is not to suggest that separate data structures may not be used) as a column within the table may indicate to which tenant(s) a record corresponds with the tags, and operations to be performed within the database may similarly be tagged so as to delineate to which tenant records a logic operation corresponds. In some embodiments, application logic database updates received from an application may include tag information, or one or more tags may be associated with logic operations of the database update received from the application (e.g., based on tenant account or other data corresponding to a logic operation).

In step 302, the centralized node may update database data, such as based on logic operations. Information about updates to database data, like database events, may be logged for updating database replicas of one or more participant nodes. Subsets of participant nodes may be associated with tenants. For example, each participant node may be permissioned to data corresponding to one or more tenants, and for each tenant a subset of participant nodes may maintain, by each participant node in the subset, a database replica of tenant data. A subset of database events may be identified as corresponding to a subset of participant nodes permissioned to that data based on tags. For example, a given unique tag associated with a database event may correspond to a respective one of the tenants (which is not to suggest that a database event cannot correspond to multiple tenants by association of multiple tags). Database events occurring between a last database update transmitted to a subset of participant nodes and a current time for generating a database update message may be aggregated into the subset of database events for updating the database replicas managed by that subset of participant nodes. Thus, for example, one or more database events occurring during a period after a prior (e.g., last) database update message may be aggregated for generation of a next database update message.

In step 303, the centralized node may determine whether to issue a block update. Block updates may be issued based on a periodic schedule (e.g., one or more minutes, hours, etc.), after a threshold number of database events within the database (e.g., after 100, 1000, 10,000, 100,000 or more events), a combination of such thresholds (e.g., every 10 minutes or 100,000 database updates), or one or more other thresholds (e.g., every 100, 1000 or more messages). If no block update is to be issued, the process 300 may proceed through steps 301 and 302 (e.g., continually updating the database and identifying database events to subsets of events for updating participant nodes) until a next database update message is generated in step 306.

If a block update is to be issued, such as in response to meeting criteria, like a threshold, the process 300 may proceed to step 304. In step 304, the centralized node may determine block header data and other information for updating one or more block tables. For example, a block number may be incremented to indicate an updated block. Database events may be associated with a block number corresponding to which block they are a member. Additionally, block header data may be determined for a block. Block header data for a block may include a state hash and a plurality of component tenant hashes on which the state hash is based. Each tenant hash may be determined based on a running sum of hashes of before and after data values (e.g., where the before and the after hashes are oppositely signed) from a subset of database events identified as associated with that tenant (e.g., based on tags of tenant identifiers) for the block. The tenant hash for a given tenant may thus be indicative of tenant data state for that tenant, and the state hash generated based on the component tenant hashes may thus be indicative of data state across one or more (or all) tenants for the database of the centralized node. In some examples, the centralized node may determine one or more other values which may be included in block header data. For example, a block hash may be determined and one or more of the block hash or other header data may be signed by the centralized node based on a private key of a key pair using a cryptographic signature algorithm (e.g., such that participant nodes may verify the signature based on a public key of the key pair).

In step 305, block information within the database may be updated by the centralized node. For example, a BlockData table may be updated to indicate the increment in block number. Additionally, a BlockHeader table may be updated to indicate the block header data for the block (e.g., block header data for the block number). Database events (e.g., modifications in the BlockData and BlockHeader tables) corresponding to block updates may be permissioned to each participant node (e.g., by a tag), and thus included within each subset of database events identified for a respective tenant.

In step 306, a database update message may be generated. In some examples, a database update message may be generated with respect to each tenant (or each tenant for which there are database events corresponding to the tenant since a last transmitted database update message for the tenant). A database update message generated with respect to a tenant may include information about database events corresponding to data of that tenant, along with any database events corresponding to block updates which are applicable to all tenants. Thus, for example, the subset of database events corresponding to a tenant that transpired since a last prior database update message was generated for that tenant may be included in a database update message for syncing tenant data at one or more participant nodes. The centralized node may generate a plurality of database update messages, such as based on a plurality of subsets of database events that each contain database events corresponding to a respective tenant.

In step 307, database update messages may be transmitted to participant nodes. The centralized node may store a mapping, like a lookup table, of tenant identifier tags to identifiers of participant nodes storing replicated data for that tenant. Thus, for example, the centralized node may identify which participant nodes are permissioned to which database update messages based on the lookup table. In turn, a database update message corresponding to a given tenant may be transmitted to the one or more identified participant nodes that maintain replica data for the given tenant in their database replicas.

In step 308, a participant node may receive a database update message. The participant node may maintain a database replica which stores a replica of all or some tenant data stored by the database of the centralized node. The participant node services received database requests for tenant data from the database replica and may be positioned (or provisioned) within a given geographic region to offload servicing of requests within that region from one or more other participant nodes. Accordingly, the participant node may be one of a plurality of geographically distributed participant nodes, and the participant node may further be a participant node in a subset of participant nodes (which may also be geographically distributed, such as within or proximate to geographically distributed offices of a tenant) that are permissioned to tenant data included within the database update message. Other subsets of participant nodes may receive other database update messages containing data of other tenants. In some examples, a participant node may be permissioned to data of multiple tenants, in which case the participant node may receive multiple database update messages that may be handle discretely, or the contents of the messages may be combined into a single database update message that may be parsed by the participant node (e.g., based on tags identifying which tenants are associated with which database events included in the update message).

In step 309, a participant node may update a database replica based on a received database update message. For example, the participant node may perform one or more operations based on database events described by the database update message. In some examples, a database update message may include one or more operations corresponding to one or more database events, which may be used by the participant node to commit, delete, or modify data within the database replica. In other examples, the participant node may determine an operation to perform based on information corresponding to a database event described in the database update message. The participant node, based on the received database update message, updates its database replica in a similar fashion to the database of the centralized node, such as to update a state of tenant data within the database replica to that of tenant data within the database (e.g., as of time of database update message generation).

The database replica, like the database of the centralized node, may store a plurality of tables, which may include information like that stored by the database in response to application logic updates. In contrast to the database of the centralized node however, the participant node updates the database replica based on information received in the database update messages, like information for performing an operation within a given table. For example, a record and associated values, like a row of data, may be added to a table within the database based on a database update message. The record may contain one or more values, such as within one or more columns of the table, and existing values may be modified or deleted or new values may be added based on database update messages. These operations within the database replica may mirror (e.g., unless there is an error) those performed within the database of the centralized node and performed with relatively low latency such that database replica data state minimally lags (e.g., based on database update message generation frequency) behind that of the database of the centralized node.

In step 310, the participant node may determine whether there is a block update. The participant node, like the centralized node, may store information about database events, like before and after values corresponding to operations performed within the database replica. Accordingly, for a database update message that includes a block update, a BlockData table may be updated to indicate an increment in block number, and a BlockHeader table may be updated to indicate the block header data for the block (e.g., block header data for the block number). Detection of database events for block update operations within the database replica may cause the participant node to verify its state, like a checkpoint for determining whether tenant data within the database replica matches that of the database of the centralized node. If no block update is received, the participant node may iterate one or more times through steps 308 and 309 to continually update the database replica in response to receipt of database update messages until there is a block update. If a block update is received, the participant node may verify database replica data state.

In step 311, the participant node may verify whether database replica data state matches that of the database of the centralized node for a block. For example, the participant node may determine a verification tenant hash based on a running sum of hashes of before and after data values (e.g., where the before and the after hashes are oppositely signed) from database events for operations performed on tenant data within the database replica. If the participant node stores replicated data for multiple tenants, the participant node may identify a subset of database events associated with each tenant (e.g., based on tags of tenant identifiers), such as to generate respective verification tenant hashes. As described above, block header data may be received in a database update message. The block header may include a component tenant hash (or hashes), among other information. The block header data may include a signature which may be verified by the participant node to ensure authenticity (e.g., was generated by the centralized node). The verification tenant hash determined by the participant node based on before and after values from operations performed to replicate tenant data within the database replica may be compared to the tenant hash determined by the centralized node that was based on before and after values from application logic operations. A match of the verification tenant hash to the tenant hash from the header data being indicative of the participant node successfully syncing database replica state to centralized node database state for the block (e.g., up to the current checkpoint). In some examples, the participant node may notify the centralized node of a successful sync for a block, such as by transmitting an acknowledgement message. If the verification tenant hash does not match the tenant hash from the block header data, the participant node may transmit a message requesting resending of a block. The participant node may unwind one or more operations performed within the database replica based on stored information about database events, such as to return the replica database to a prior state (e.g., a state corresponding to a prior block that successfully synced) before processing one or more database messages resent by the centralized node to re-sync a block for which verification initially failed.

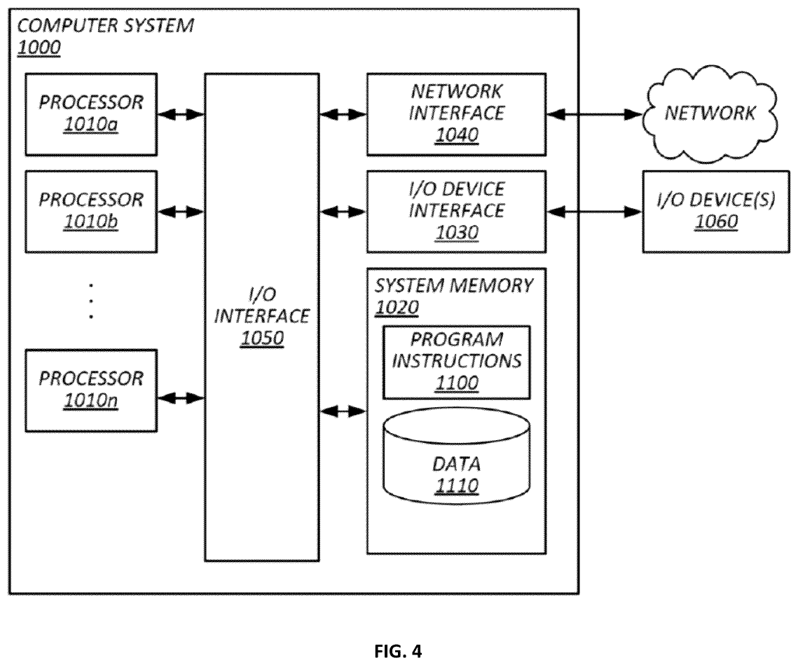

FIG. 4 which is a diagram that illustrates an example computing system 1000 in accordance with embodiments of the present techniques. Various portions of systems and methods described herein may include or be executed on one or more computer systems similar to computing system 1000. For example, all or some steps like those described above may be executed on one or more computer systems which may be similar to computing system 1000. Further, one or more modules and processes like those described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A tangible, non-transitory, machine-readable medium storing instructions that when executed by one or more processors effectuate operations comprising:
updating, by a computing system and based on a database update, database data stored in a database within a multi-tenant environment, wherein the database data stored in the database includes tenant data that is associated with one or more tenants and respective tenant data for a respective tenant is maintained by one or more participant nodes as one or more respective database replicas of the respective tenant data;
generating, the computing system, one or more database update messages, wherein each database update message is generated with respect to each tenant for which there are database events corresponding to that tenant since a last transmitted database update message for that tenant; and
transmitting, the computing system, the one or more database update messages to one or more participant nodes that maintain a data replica for the respective tenant identified in the one or more database update messages.

2. The tangible, non-transitory, machine-readable medium of claim 1, wherein the computing system is a centralized node of the multi-tenant environment.

3. The tangible, non-transitory, machine-readable medium of claim 1, wherein database update may include a plurality of database events occurring between a last database update.

4. The tangible, non-transitory, machine-readable medium of claim 1, wherein the transmitting the one or more database update messages to the one or more participant nodes causes each participant node to:
update a database replica associated with a tenant identified in a database update message of the one or more participant nodes received by that participant node based on the database events in the database update message corresponding to the tenant associated with the database replica.

5. The tangible, non-transitory, machine-readable medium of claim 4, wherein the operations further comprise:
in response to determining that a block update condition is satisfied, determining block header data and other information for updating one or more block tables; and
updating a block information in the one or more block tables.

6. The tangible, non-transitory, machine-readable medium of claim 5, wherein the database events include the update to the block information in the one or more block tables.

7. The tangible, non-transitory, machine-readable medium of claim 5, wherein the updating the block information in the one or more block tables includes an update to a block data table indicating an increment in a block number of a block and an update to a block header table to indicate block header data for the block.

8. The tangible, non-transitory, machine-readable medium of claim 7, wherein the block header data for the block may include a state hash and a plurality of component tenant hashes on which the state has is based, wherein each tenant hash of the plurality of component tenant hashes is based on a running sum of hashes of before and after data values from a subset of database events identified as associated with that tenant for the block.

9. The tangible, non-transitory, machine-readable medium of claim 8, wherein the block header data is signed with a private key of a key pair using a cryptographic signature algorithm.

10. The tangible, non-transitory, machine-readable medium of claim 6, wherein the transmitting the one or more database update messages to the one or more participant nodes causes each participant node to:
in response to determining there is a block update in the block information provided in the database events, verify whether a database replica data state matches that of the database.

11. The tangible, non-transitory, machine-readable medium of claim 10, wherein the operations further comprise:
receiving, by the computing system, a message to resend a block, from a participant node in response to that participant node determining that the database replica data state does not match that of the database.

12. The tangible, non-transitory, machine-readable medium of claim 10, wherein the operations further comprise steps for:
identifying a participant node associated with the tenant data.

13. A tangible, non-transitory, machine-readable medium storing instructions that when executed by one or more processors effectuate operations comprising:
receiving, by a computing system that maintains a first database replica for a first tenant, a first database update message,
wherein the first database replica for the first tenant is a replica of first tenant data of the first tenant stored in a database within a multi-tenant environment that is maintained by a centralized node,
wherein the first database update message includes database events corresponding to the first tenant data for the first tenant since a last transmitted database update message for the first tenant, and
wherein the database events include block information;
updating, by the computing system, first database replica tenant data in the first database replica based on the database events in the first database update message corresponding to the first tenant associated with the first database replica;
in response to determining there is a block update in the block information provided in the database events, verifying, by the computing system, whether a database replica data state matches that of a database data state of the database maintained by the centralized node and included in the block information; and
in response to determining that the database replica data state does not match the database data state, transmitting a message to the centralized node to resend a block of database events transmitted in the first database update message for the first tenant since a last block update.

14. The tangible, non-transitory, machine-readable medium of claim 13, wherein the operations further comprise:
unwinding, by the computing system, one or more operations performed within the first database replica to return the first database replica to a prior state of the last block update;
receiving, by the computing system, the block of database events transmitted in the first database update message for the first tenant since the last block updated; and
updating, by the computing system, the first database replica at the prior state with the database events since the last block update.

15. The tangible, non-transitory, machine-readable medium of claim 14, wherein the database replica data state includes a tenant hash that is a hash determined based on before values and after values performed on the first database replica tenant data since the last block update, and the database data state includes a component tenant hash determined by the centralized node that was based on before values and after values of the first tenant data at the database since the last block update.

16. The tangible, non-transitory, machine-readable medium of claim 13, wherein the block information is cryptographically signed with a private key by the centralized node to include a signature and the operations further comprise:
verifying, by the computing system, the signature with a public key this is a key pair with the private key.

17. The tangible, non-transitory, machine-readable medium of claim 13, wherein the operations further comprise:
updating block information in one or more block tables with the block information received in the first database update message.

18. The tangible, non-transitory, machine-readable medium of claim 13, wherein the computing system is a participant node of the multi-tenant environment.

19. The tangible, non-transitory, machine-readable medium of claim 13, wherein the operations further comprise:
receiving, by the computing system that maintains a second database replica for a second tenant, a second database update message,
wherein the second database replica for the second tenant is a replica of second tenant data of the second tenant stored in the database that is maintained by the centralized node, and
wherein the second database update message includes database events corresponding to the second tenant data for the second tenant since a last transmitted database update message for the second tenant; and
updating, by the computing system, second replica tenant data in the second database replica based on the database events in the second database update message corresponding to the second tenant associated with the second database replica.

20. A method, comprising:
receiving, by a computing system that maintains a first database replica for a first tenant, a first database update message,
wherein the first database replica for the first tenant is a replica of first tenant data of the first tenant stored in a database within a multi-tenant environment that is maintained by a centralized node,
wherein the first database update message includes database events corresponding to the first tenant data for the first tenant since a last transmitted database update message for the first tenant, and
wherein the database events include block information;
updating, by the computing system, first database replica tenant data in the first database replica based on the database events in the first database update message corresponding to the first tenant associated with the first database replica;
in response to determining there is a block update in the block information provided in the database events, verifying, by the computing system, whether a database replica data state matches that of a database data state of the database maintained by the centralized node and included in the block information; and
in response to determining that the database replica data state does not match the database data state, transmitting a message to the centralized node to resend a block of database events transmitted in the first database update message for the first tenant since a last block update.
